(19) United States
(12) Patent Application Publication
(10) Pub. No.: US 2009/0115153 A1
(43) Pub. Date: May 7, 2009

(54) Upper Link Mount for Truck Axle

(76) Inventor: Kevin Anton Guhman, Glendale, AZ (US)

Correspondence Address: Kevin Anton Guhman, 4480 West Palmaire Avenue, Glendale, AZ, 85301, US

(21) Appl. No.: 12/262,247

(22) Filed: Oct. 31, 2008

Related U.S. Application Data
(60) Provisional application No. 61/001,623, filed on Nov. 1, 2007.

(51) Int. Cl. B60G 9/02

(52) U.S. Cl. 280/124.11

(57) ABSTRACT

An upper link mount that is functional. An “A” shaped part is oriented with the point facing towards the center of the vehicle. The base of the “A” is attached to the axle with screws. The tip of the “A” has two holes to mount upper links to. Servo mounting holes can be incorporated into this “A” shaped part as well to hold a steering servo.

### RELATED APPLICATIONS

The present application is a continuation application of U.S. provisional patent application Ser. No. 61/001,623, filed Nov. 1, 2007, for UPPER LINK MOUNT FOR ROCK CRAWLER, by Kevin Anton Guhman, included by reference herein and for which benefit of the priority date is hereby claimed.

### FIELD OF THE INVENTION

The present invention relates to link mounts and, more particularly, to a link mount that has a minimal amount of parts and provides a means to directly attach links and rod ends to a solid attachment point.

### BACKGROUND OF THE INVENTION

The company Axial Racing produced a rock crawler toy car named the AX10 Scorpion. The upper links system on this vehicle was week, prone to failure, and contained slop. A stronger, more reliable, and more secure and accurate form of upper link mounting was needed. This concept can be applied to many other vehicles and vehicle types.

Prior art upper link mounts are prone to failure and this increases as components are added to the axle and the weight of the axle increases.

It would be advantageous to provide a means to attach upper links.

It would also be advantageous to provide an upper link mount that is strong.

It would also be advantageous to provide an upper link mount that is resistant to breaking.

It would further be advantageous to provide an upper link mount that does not have any slop.

### SUMMARY OF THE INVENTION

In accordance with the present invention, there is provided an upper link mount that is functional. An “A” shaped part is oriented with the point facing towards the center of the vehicle. The base of the “A” is attached to the axle with screws. The tip of the “A” has two holes to mount upper links to. Servo mounting holes can be incorporated into this “A” shaped part as well to hold a steering servo.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top perspective view of a FIG. 1 is a top perspective view of an upper link mount for truck axle; and

FIG. 2 is a top view of a FIG. 2 is a top view of an upper link mount for truck axle with an integrated servo mount.

For purposes of clarity and brevity, like elements and components will bear the same designations and numbering throughout the Figures.

### DESCRIPTION OF THE PREFERRED EMBODIMENT

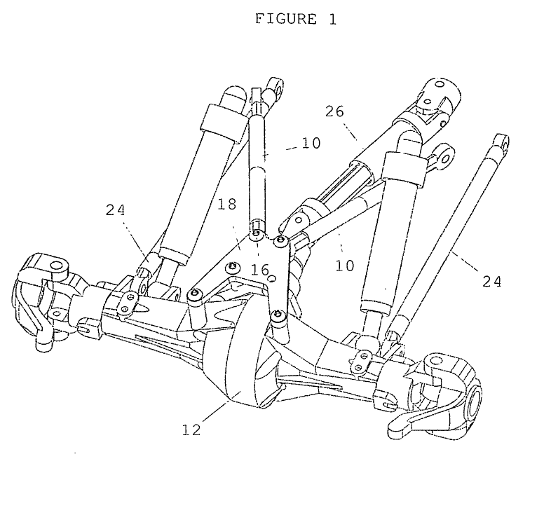

FIG. 1 is a top perspective view of an upper link mount for truck axle 12. Upper link mount 18 is installed onto truck axle 12 with hardware 16. Upper links 10 are attached directly to the upper link mount 18 with hardware 16. Upper links 10 have rod ends at the end of the upper links 10 that allow for a certain degree of rotational movement. This allows truck axle 12 to move up and down and to articulate. Upper link mount 18 adapts the available mounting positions on truck axle to hole locations that are properly adjusted to give truck axle 12 the proper geometry for its intended purpose (rock crawling, off road use, etc.). Upper links 10 can be mounted on top, below, or a combination of on top and below the upper link mount 18. Upper link mount 18 has a radius' around the upper links 10 mounting holes that allow for the maximum clearance of the upper links 10 to provide for maximum movement of the truck axle 12. Upper link mount 18 is designed with the minimal amount of material as possible to minimize weight. This design can be adapted to many different axle types. Upper link mount 18 can be made of any strong material such as metal, plastic, composite, or any other suitable material. Upper link mount 18 can be made of flat material, or made with some 3 dimensional elements.

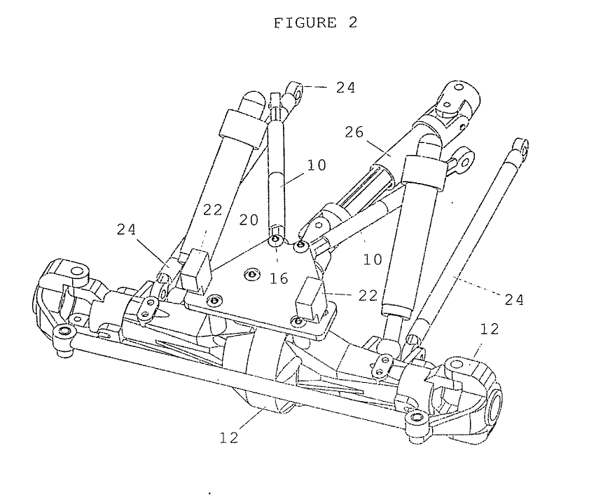

FIG. 2 is a top view of an upper link mount 18 for truck axle 12 with an integrated servo mount. Upper link mount with integrated servo mount 20 is installed onto truck axle 12 with hardware 16. Upper links 10 are attached directly to the upper link mount with integrated servo mount 20 with hardware 16. Servo mounts 22 are attached to Upper link mount with integrated servo mount 20 to allow the mounting of a steering servo. Upper links 10 have rod ends at the end of the upper links 10 that allow for a certain degree of rotational movement. This allows truck axle 12 to move up and down and to articulate. Upper link mount with integrated servo mount 20 adapt the available mounting positions on truck axle 12 to hole locations that are properly adjusted to give truck axle 12 the proper geometry for its intended purpose (rock crawling, off road use, etc.). Upper links 10 can be mounted on top, below, or a combination of on top and below the upper link mount with integrated servo mount 20. Upper link mount with integrated servo mount 20 has a radius' around the upper links 10 mounting holes that allow for the maximum clearance of the upper links 10 to provide for maximum movement of the truck axle 12. Upper link mount with integrated servo mount 20 is designed with the minimal amount of material as possible to minimize weight. This design can be adapted to many different axle types. Upper link mount with integrated servo mount 20 can be made of any strong material such as metal, plastic, composite, or any other suitable material. Upper link mount with integrated servo mount 20 can be made of flat material, or made with some 3 dimensional elements.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An upper link mount for truck axle for an upper link mount used to attach the upper links of a truck to the axle, comprising:
means for attaching the upper link mount to the other components in the system;
means for creating a strong link between the links and truck axle;
means for creating a strong link between the links and truck axle, rigidly connected to said means for attaching the upper link mount to the other components in the system; and
means for attaching a servo to the upper link mount, rigidly connected to said means for attaching the upper link mount to the other components in the system.

2. The upper link mount for truck axle in accordance with claim 1, wherein said means for attaching the upper link mount to the other components in the system comprises a hardware.

3. The upper link mount for truck axle in accordance with claim 1, wherein said means for creating a strong link between the links and truck axle comprises a flat upper link mount.

4. The upper link mount for truck axle in accordance with claim 1, wherein said means for creating a strong link between the links and truck axle comprises a flat upper link mount with integrated servo mount.

5. The upper link mount for truck axle in accordance with claim 1, wherein said means for attaching a servo to the upper link mount comprises a servo mounts.

6. An upper link mount for truck axle for an upper link mount used to attach the upper links of a truck to the axle, comprising:
a hardware, for attaching the upper link mount to the other components in the system;
a flat upper link mount, for creating a strong link between the links and truck axle;
a flat upper link mount with integrated servo mount, for creating a strong link between the links and truck axle, rigidly connected to said hardware; and
a servo mounts, for attaching a servo to the upper link mount, rigidly connected to said hardware.

7. The upper link mount for truck axle as recited in claim 6, wherein said upper link mount is plastic.

8. The upper link mount for truck axle as recited in claim 6, wherein said upper link mount with integrated servo mount is plastic.

9. The upper link mount for truck axle as recited in claim 7, wherein said upper link mount with integrated servo mount is plastic.

10. An upper link mount for truck axle for an upper link mount used to attach the upper links of a truck to the axle, comprising:
a hardware, for attaching the upper link mount to the other components in the system;
a flat, plastic upper link mount, for creating a strong link between the links and truck axle;
a flat, plastic upper link mount with integrated servo mount, for creating a strong link between the links and truck axle, rigidly connected to said hardware; and
a servo mounts, for attaching a servo to the upper link mount, rigidly connected to said hardware.
